(19) United States
(12) Patent Application Publication
(10) Pub. No.: US 2019/0295215 A1
(43) Pub. Date: Sep. 26, 2019

(54) IMAGE PROCESSING DEVICE, IMAGE PROCESSING METHOD, AND PROGRAM

(71) Applicant: FUJIFILM Corporation, Tokyo (JP)

(72) Inventors: Yasunobu KISHINE, Saitama-shi (JP); Yoshiaki ISHII, Saitama-shi (JP); Kenkichi HAYASHI, Saitama-shi (JP); Yosuke NARUSE, Saitama-shi (JP)

(73) Assignee: FUJIFILM Corporation, Tokyo (JP)

(21) Appl. No.: 16/441,848

(22) Filed: Jun. 14, 2019

Related U.S. Application Data
(63) Continuation of application No. PCT/JP2017/041232, filed on Nov. 16, 2017.

(30) Foreign Application Priority Data
Jan. 6, 2017 (JP) 2017-001273

(51) Int. Cl. G06T 3/00; H04N 5/232; G06T 3/40

(52) U.S. Cl. CPC G06T 3/0068; G06T 3/4038; H04N 5/23238

(57) ABSTRACT

Provided are an image processing device, an image processing method, and a non-transitory computer readable recording medium storing a program which generate a favorable-quality combination image of which distortion is partially corrected with no calculation cost. A plurality of images captured by a plurality of cameras is input, and scaling processing is performed on at least one image of two images to be combined with each other among the plurality of images in a direction perpendicular to a direction in which the two images are combined. A continuous combination image is generated by combining the plurality of images after the scaling processing. The scaling processing is performed on at least the one image of the two images according to a predetermined scaling ratio, and a misalignment on an image of a combined portion of the two images to be combined with each other in the perpendicular direction is suppressed.

### CROSS-REFERENCE TO RELATED APPLICATIONS

This application is a Continuation of PCT International Application No. PCT/JP2017/041232 filed on Nov. 16, 2017, which claims priority under 35 U.S.C § 119(a) to Japanese Patent Application No. 2017-001273 filed on Jan. 6, 2017. Each of the above application(s) is hereby expressly incorporated by reference, in its entirety, into the present application.

### BACKGROUND OF THE INVENTION

### 1. Field of the Invention

The present invention relates to an image processing device, an image processing method, and a non-transitory computer readable recording medium storing a program, and particularly to an image processing device, an image processing method, and a non-transitory computer readable recording medium storing a program which generate a combination image by combining images captured by a plurality of cameras.

### 2. Description of the Related Art

In the related art, in a case where a subject larger than an angle of view of an imaging lens of a camera is captured in a split manner by multiple number of times (split imaging), a technology for generating a combination image by combining the split-captured images (split images) is suggested.

For example, JP2011-139367A suggests a technology in a case where the split images obtained by imaging the subject in the split manner by one camera are combined.

### SUMMARY OF THE INVENTION

Embodiments related to the technology of the present disclosure provide an image processing device, an image processing method, and a non-transitory computer readable recording medium storing a program.

An image processing device which is an aspect of the present disclosure for achieving the object comprises: an image input unit that receives, as inputs, a plurality of images captured by a plurality of cameras; a scaling processing unit that performs scaling processing on at least one image of two images to be combined with each other among the plurality of images in only a direction perpendicular to a direction in which the two images are combined; and a combination image generation unit that combines the plurality of images after the scaling processing using the scaling processing unit, and generates a continuous combination image. The scaling processing unit performs the scaling processing on at least the one image of the two images according to a predetermined scaling ratio, and suppresses a misalignment on an image of a combined portion at which the two images are combined with each other in the perpendicular direction.

An image processing device which is another aspect of the present disclosure comprises: an image input unit that receives, as inputs, a plurality of images captured by a plurality of cameras; a first scaling processing unit that performs scaling processing on at least one image of two images to be combined with each other among the plurality of images in a direction perpendicular to a direction in which the two images are combined; a second scaling processing unit that performs the scaling processing on a partial image including an image of a combined portion, at which the two images are combined with each other, of at least the one image of the two images in the direction in which the two images are combined; and a combination image generation unit that combines the plurality of images after the scaling processing using the first scaling processing unit and the second scaling processing unit, and generates a continuous combination image. The first scaling processing unit performs the scaling processing on at least the one image of the two images according to a first predetermined scaling ratio, and suppresses a misalignment on the image of the combined portion of the two images to be combined with each other in the perpendicular direction, and the second scaling processing unit performs the scaling processing on the partial image according to a second predetermined scaling ratio, suppresses a misalignment or distortion on the image of the combined portion of the two images to be combined with each other, and causes the image to be continuous in the combination direction.

An image processing method which is still another aspect of the present disclosure comprises: an image input step of receiving, as inputs, a plurality of images captured by a plurality of cameras; a scaling processing step of performing scaling processing on at least one image of two images to be combined with each other among the plurality of images in only a direction perpendicular to a direction in which the two images are combined; and a combination image generation step of combining the plurality of images after the scaling processing in the scaling processing step, and generating a continuous combination image. In the scaling processing step, the scaling processing is performed on at least the one image of the two images according to a predetermined scaling ratio, and a misalignment on an image of a combined portion at which the two images are combined with each other in the perpendicular direction is suppressed.

An image processing method which is still another aspect of the present disclosure comprises: an image input step of receiving, as inputs, a plurality of images captured by a plurality of cameras; a first scaling processing step of performing scaling processing on at least one image of two images to be combined with each other among the plurality of images in a direction perpendicular to a direction in which the two images are combined; a second scaling processing step of performing the scaling processing on a partial image including an image of a combined portion, at which the two images are combined with each other, of at least the one image of the two images in the direction in which the two images are combined; and a combination image generation step of combining the plurality of images after the scaling processing in the first scaling processing step and the second scaling processing step, and generating a continuous combination image. In the first scaling processing step, the scaling processing is performed on at least the one image of the two images according to a first predetermined scaling ratio, and a misalignment on the image of the combined portion of the two images to be combined with each other in the perpendicular direction is suppressed, and in the second scaling processing step, the scaling processing is performed on the partial image of at least the one image of the two images according to a second predetermined scaling ratio, a misalignment or distortion on the image of the combined portion of the two images to be combined with each other is suppressed, and the image is continuous in the combination direction.

A non-transitory computer readable recording medium storing a program which is still another aspect of the present disclosure causes a computer to perform: an image processing method including an image input step of receiving, as inputs, a plurality of images captured by a plurality of cameras, a scaling processing step of performing scaling processing at least one image of two images to be combined with each other among the plurality of images in only a direction perpendicular to a direction in which the two images are combined, and a combination image generation step of combining the plurality of images after the scaling processing in the scaling processing step, and generating a continuous combination image. In the scaling processing step, the scaling processing is performed on at least the one image of the two images according to a predetermined scaling ratio, and a misalignment on an image of a combined portion at which the two images are combined with each other in the perpendicular direction is suppressed.

A non-transitory computer readable recording medium storing a program which is still another aspect of the present disclosure causes a computer to perform: an image processing method including an image input step of receiving, as inputs, a plurality of images captured by a plurality of cameras, a first scaling processing step of performing scaling processing on at least one image of two images to be combined with each other among the plurality of images in a direction perpendicular to a direction in which the two images are combined, a second scaling processing step of performing the scaling processing on a partial image including an image of a combined portion, at which the two images are combined with each other, of at least the one image of the two images in the direction in which the two images are combined, and a combination image generation step of combining the plurality of images after the scaling processing in the first scaling processing step and the second scaling processing step, and generating a continuous combination image. In the first scaling processing step, the scaling processing is performed on at least the one image of the two images according to a first predetermined scaling ratio, and a misalignment on the image of the combined portion of the two images to be combined with each other in the perpendicular direction is suppressed, and in the second scaling processing step, the scaling processing is performed on the partial image of at least the one image of the two images according to a second predetermined scaling ratio, a misalignment or distortion on the image of the combined portion of the two images to be combined with each other is suppressed, and the image is continuous in the combination direction.

### BRIEF DESCRIPTION OF THE DRAWINGS

FIG. 1 is a conceptual diagram showing a computer included in an image processing device and a plurality of cameras.

FIG. 2 is a block diagram showing functions of the camera connected to the computer.

FIG. 3 is a block diagram showing functions of a computer-side image processing unit (image processing device).

FIG. 4 is a diagram for describing an apparent misalignment in a case where images having different sizes are combined.

FIG. 5 is a diagram for describing the apparent misalignment in a case where the images having different sizes are combined.

FIG. 6 is a diagram showing an outline until a combination image is generated.

FIG. 7 is a flowchart showing an image processing method.

FIG. 8 is a block diagram showing functions of the image processing unit (image processing device).

FIG. 9 is a diagram for describing scaling processing in an H direction.

FIG. 10 is a diagram for describing the scaling processing in the H direction.

FIG. 11 is a flowchart showing the image processing method.

FIG. 12 is a diagram showing an example of a combination image.

FIG. 13 is a diagram showing an example of the combination image.

FIG. 14 is a diagram showing an example of the combination image.

FIG. 15 is a diagram showing an example of a captured image.

FIG. 16 is a diagram showing an example of the combination image.

### DESCRIPTION OF THE PREFERRED EMBODIMENTS

According to the present disclosure, since the scaling correction for correcting the distortion at the combined portion of the image and the image is performed as the scaling correction for leaving the distortion at a partial portion on the two images to be combined, it is possible to obtain the combination image in which the distortion of the combination image is effectively corrected by suppressing the calculation cost for the scaling correction.

An image processing device which is an aspect of the present disclosure for achieving the object comprises: an image input unit that receives, as inputs, a plurality of images captured by a plurality of cameras; a scaling processing unit that performs scaling processing on at least one image of two images to be combined with each other among the plurality of images in only a direction perpendicular to a direction in which the two images are combined; and a combination image generation unit that combines the plurality of images after the scaling processing using the scaling processing unit, and generates a continuous combination image. The scaling processing unit performs the scaling processing on at least the one image of the two images according to a predetermined scaling ratio, and suppresses a misalignment on an image of a combined portion at which the two images are combined with each other in the perpendicular direction.

According to the present aspect, the scaling processing unit performs the scaling correction on at least the one image of the two images to be combined with each other among the plurality of images in only the direction perpendicular to the direction in which the two images are combined. Accordingly, in the present aspect, since the scaling correction is performed in only the direction perpendicular to the direction in which the two images are combined, it is possible to reduce the calculation cost required for the scaling correction. That is, it is possible to effectively correct the distortion of the entire combination image by performing the scaling processing in the direction perpendicular to the combination direction.

According to the present aspect, the scaling processing unit performs the scaling processing on at least the one image of the two images according to the predetermined scaling ratio, and thus, the misalignment on the image of the combined portion of the two images to be combined with each other in the perpendicular direction is suppressed. Accordingly, in the present aspect, since the misalignment on the image of the combined portion of the two images in the perpendicular direction is suppressed, the distortion on the image of the combined portion of the two images is corrected, and thus, it is possible to obtain the favorable-quality combination image in which the distortion is effectively corrected on the combination image.

Preferably, the scaling processing unit performs the scaling processing according to the predetermined scaling ratio, and aligns a size of the image of the combined portion.

According to the present aspect, since the scaling processing unit aligns the size of the image of the combined portion, it is possible to obtain the favorable-quality combination image in which the distortion of the combined portion of the combination image is effectively corrected.

Preferably, the scaling processing unit performs the scaling processing according to the predetermined scaling ratio corresponding to a position of the one image in the perpendicular direction.

According to the present aspect, since the scaling processing unit performs the scaling processing according to the predetermined scaling ratio corresponding to the position of the one image in the perpendicular direction, it is possible to obtain the favorable-quality image in which the distortion is appropriately corrected in the position on the image of the combined portion.

Preferably, the scaling processing unit performs the scaling processing according to the predetermined scaling ratio corresponding to pixels of the one image in the perpendicular direction.

According to the present aspect, since the scaling processing unit performs the scaling processing according to the predetermined scaling ratio corresponding to the pixels of the image of the combined portion in the perpendicular direction, it is possible to obtain the favorable-quality image in which the distortion is appropriately corrected for each pixel on the image of the combined portion of the two images.

Preferably, the scaling processing unit performs the scaling processing on at least the one image of the two images as a whole according to the same predetermined scaling ratio.

According to the present aspect, since the scaling processing unit performs the scaling processing on at least the one image of the two images as a whole according to the same scaling ratio, it is possible to obtain the favorable-quality image in which the distortion in the direction perpendicular to the combination direction is suppressed on the entire image.

An image processing device which is another aspect of the present disclosure comprises: an image input unit that receives, as inputs, a plurality of images captured by a plurality of cameras; a first scaling processing unit that performs scaling processing on at least one image of two images to be combined with each other among the plurality of images in a direction perpendicular to a direction in which the two images are combined; a second scaling processing unit that performs the scaling processing on a partial image including an image of a combined portion, at which the two images are combined with each other, of at least the one image of the two images in the direction in which the two images are combined; and a combination image generation unit that combines the plurality of images after the scaling processing using the first scaling processing unit and the second scaling processing unit, and generates a continuous combination image. The first scaling processing unit performs the scaling processing on at least the one image of the two images according to a first predetermined scaling ratio, and suppresses a misalignment on the image of the combined portion of the two images to be combined with each other in the perpendicular direction, and the second scaling processing unit performs the scaling processing on the partial image according to a second predetermined scaling ratio, suppresses a misalignment or distortion on the image of the combined portion of the two images to be combined with each other, and causes the image to be continuous in the combination direction.

According to the present aspect, the first scaling processing unit performs the scaling correction on at least the one image of the two images to be combined with each other among the plurality of images in the direction perpendicular to the direction in which the two images are combined. Accordingly, in the present aspect, since the scaling correction is performed in the direction perpendicular to the direction in which the two images are combined, it is possible to reduce calculation cost required for the scaling correction. That is, it is possible to effectively correct the distortion of the entire combination image by performing the scaling processing in the direction perpendicular to the combination direction.

According to the present aspect, the first scaling processing unit performs the scaling processing on at least the one image of the two images according to the first predetermined scaling ratio, and the misalignment on the image of the combined portion of the two images to be combined with each other in the perpendicular direction is suppressed. Accordingly, in the present aspect, since the misalignment on the image of the combined portion of the two images in the perpendicular direction is suppressed, the distortion on the image of the combined portion of the two images is corrected, and thus, it is possible to obtain the favorable-quality combination image in which the distortion is effectively corrected on the combination image.

According to the present aspect, the second scaling processing unit performs the scaling processing on the partial image including the image of the combined portion of at least the one image of the two images in the direction in which the two images are combined. Accordingly, in the present aspect, since the scaling correction is performed on not the entire image but the partial image including the image of the combined portion in the direction in which the two images are combined, it is possible to reduce the calculation cost required for the scaling correction.

According to the present aspect, the second scaling processing unit performs the scaling processing on the partial image according to the second predetermined scaling ratio, and causes the image of the combined portion of the two images to be combined with each other to be continuous in the combination direction. Accordingly, in the present aspect, it is possible to obtain the favorable-quality combination image in which the image of the combined portion of the two images is continuous and the distortion is effectively corrected on the combination image.

Preferably, the first scaling processing unit performs the scaling processing according to the first predetermined scaling ratio, and aligns a size of the image of the combined portion.

According to the present aspect, since the first scaling processing unit aligns the size of the image of the combined portion, it is possible to obtain the favorable-quality combination image in which the distortion of the combined portion of the combination image is effectively corrected.

Preferably, the first scaling processing unit performs the scaling processing according to the first predetermined scaling ratio corresponding to a position of the one image in the perpendicular direction.

According to the present aspect, since the first scaling processing unit performs the scaling processing according to the first predetermined scaling ratio corresponding to the position of the one image in the perpendicular direction, it is possible to obtain the favorable-quality image in which the distortion is appropriately corrected in the position on the image of the combined portion.

Preferably, the first scaling processing unit performs the scaling processing according to the first predetermined scaling ratio corresponding to pixels of the one image in the perpendicular direction.

According to the present aspect, since the first scaling processing unit performs the scaling processing according to the first predetermined scaling ratio corresponding to the pixels of the image of the combined portion in the perpendicular direction, it is possible to obtain the favorable-quality image in which the distortion is corrected for each pixel on the image of the combined portion of the two images.

Preferably, the first scaling processing unit performs the scaling processing on at least the one image of the two images as a whole according to the same first predetermined scaling ratio.

According to the present aspect, since the first scaling processing unit performs the scaling processing on at least the one image of the two images as a whole according to the same first predetermined scaling ratio, it is possible to obtain the favorable-quality image of which distortion is suppressed in the combination direction and the perpendicular direction on the entire image.

Preferably, the second scaling processing unit performs the scaling processing on the partial image depending on a position of the one image in the perpendicular direction.

According to the present aspect, since the second scaling processing unit performs the scaling processing on the partial image depending on the position in the direction perpendicular to the combination direction, it is possible to obtain the favorable-quality image in which the distortion is appropriately corrected on the image of the combined portion depending on the positions in the direction perpendicular to the combination direction.

Preferably, the second scaling processing unit performs the scaling processing on the partial image depending on pixels of the one image in the perpendicular direction.

According to the present aspect, since the second scaling processing unit performs the scaling processing depending on the pixels of the combined portion in the direction perpendicular to the combination direction, it is possible to obtain the favorable-quality image in which the distortion is appropriately corrected depending on the pixels.

Preferably, the partial image has a width of 1% or more and 10% or less of a length of one side of the image to be combined in the combination direction.

According to the present aspect, the combined portion has the width of 1% or more and 10% or less of the length of one side of the image in the combination direction. Accordingly, in the present aspect, since distortion of an area having a width of 1% or more and 10% or less of the length of one side of the image in the combination direction is corrected, the calculation cost required for the scaling correction is suppressed, and it is possible to effectively correct the distortion of the combination image.

Preferably, the image processing device further comprises: a sharpness processing unit that performs sharpness processing on the plurality of images on which the scaling processing is performed.

According to the present aspect, since the combination image is generated by performing the sharpness processing on the plurality of images on which the scaling correction is performed by the sharpness processing unit and combining the images on which the sharpness processing is performed, it is possible to obtain the favorable-quality combination image.

Preferably, distortion is caused over five pixels or less on the combination image generated by the combination image generation unit.

According to the present aspect, in a case where the combination image is generated without performing the scaling correction even though the distortion is caused over five pixels or more on the image input by the input unit, the quality of the combination image is not favorable. However, even in a case where the distortion is caused over five pixels or more on the image input as in the present aspect, it is possible to obtain the favorable-quality combination image in which the distortion is caused over five pixels or less by performing the scaling correction in which the calculation cost is suppressed by performing the scaling correction of the present aspect. The image used for the combination image is captured by a wide-angle lens capable of imaging a wider region in many cases, and the wide-angle lens is greatly distorted. Accordingly, in the present aspect, in a case where the distortion of the image obtained by the camera comprising the wide-angle lens is corrected, it is possible to perform image processing in which the calculation cost is further suppressed.

An image processing method which is still another aspect of the present disclosure comprises: an image input step of receiving, as inputs, a plurality of images captured by a plurality of cameras; a scaling processing step of performing scaling processing on at least one image of two images to be combined with each other among the plurality of images in only a direction perpendicular to a direction in which the two images are combined; and a combination image generation step of combining the plurality of images after the scaling processing in the scaling processing step, and generating a continuous combination image. In the scaling processing step, the scaling processing is performed on at least the one image of the two images according to a predetermined scaling ratio, and a misalignment on an image of a combined portion at which the two images are combined with each other in the perpendicular direction is suppressed.

An image processing method which is still another aspect of the present disclosure comprises: an image input step of receiving, as inputs, a plurality of images captured by a plurality of cameras; a first scaling processing step of performing scaling processing on at least one image of two images to be combined with each other among the plurality of images in a direction perpendicular to a direction in which the two images are combined; a second scaling processing step of performing the scaling processing on a partial image including an image of a combined portion, at which the two images are combined with each other, of at least the one image of the two images in the direction in which the two images are combined; and a combination image generation step of combining the plurality of images after the scaling processing in the first scaling processing step and the second scaling processing step, and generating a continuous combination image. In the first scaling processing step, the scaling processing is performed on at least the one image of the two images according to a first predetermined scaling ratio, and a misalignment on the image of the combined portion of the two images to be combined with each other in the perpendicular direction is suppressed, and in the second scaling processing step, the scaling processing is performed on the partial image of at least the one image of the two images according to a second predetermined scaling ratio, a misalignment or distortion on the image of the combined portion of the two images to be combined with each other is suppressed, and the image is continuous in the combination direction.

A non-transitory computer readable recording medium storing a program which is still another aspect of the present disclosure causes a computer to perform: an image processing method including an image input step of receiving, as inputs, a plurality of images captured by a plurality of cameras, a scaling processing step of performing scaling processing at least one image of two images to be combined with each other among the plurality of images in only a direction perpendicular to a direction in which the two images are combined, and a combination image generation step of combining the plurality of images after the scaling processing in the scaling processing step, and generating a continuous combination image. In the scaling processing step, the scaling processing is performed on at least the one image of the two images according to a predetermined scaling ratio, and a misalignment on an image of a combined portion at which the two images are combined with each other in the perpendicular direction is suppressed.

A non-transitory computer readable recording medium storing a program which is still another aspect of the present disclosure causes a computer to perform: an image processing method including an image input step of receiving, as inputs, a plurality of images captured by a plurality of cameras, a first scaling processing step of performing scaling processing on at least one image of two images to be combined with each other among the plurality of images in a direction perpendicular to a direction in which the two images are combined, a second scaling processing step of performing the scaling processing on a partial image including an image of a combined portion, at which the two images are combined with each other, of at least the one image of the two images in the direction in which the two images are combined, and a combination image generation step of combining the plurality of images after the scaling processing in the first scaling processing step and the second scaling processing step, and generating a continuous combination image. In the first scaling processing step, the scaling processing is performed on at least the one image of the two images according to a first predetermined scaling ratio, and a misalignment on the image of the combined portion of the two images to be combined with each other in the perpendicular direction is suppressed, and in the second scaling processing step, the scaling processing is performed on the partial image of at least the one image of the two images according to a second predetermined scaling ratio, a misalignment or distortion on the image of the combined portion of the two images to be combined with each other is suppressed, and the image is continuous in the combination direction.

Hereinafter, preferred embodiments of an image processing device, an image processing method, and a non-transitory computer readable recording medium storing a program according to an embodiment of the present disclosure will be described with reference to the accompanying drawings.

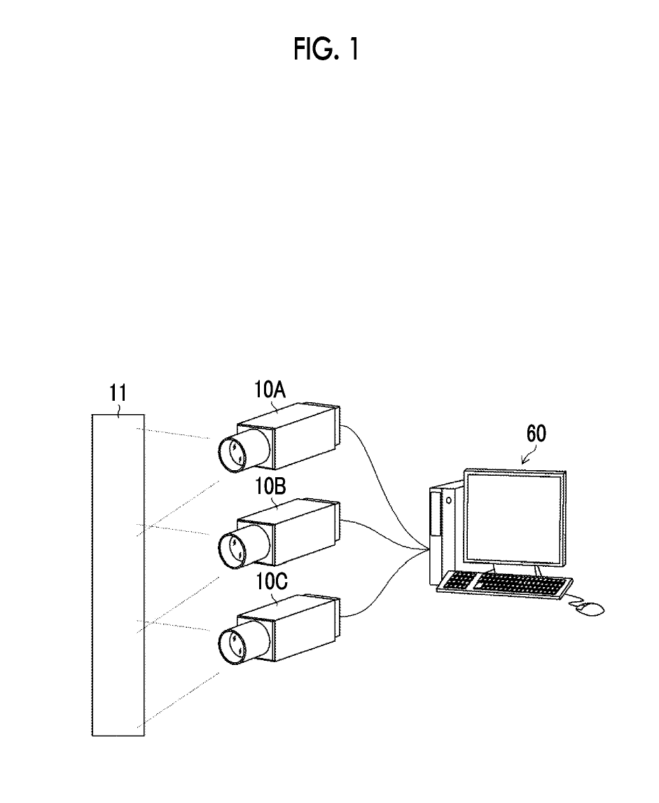

FIG. 1 is a conceptual diagram showing a computer included in the image processing device according to the embodiment of the present disclosure and a plurality of cameras connected to the computer.

In the case shown in FIG. 1, a subject 11 is captured in a split manner by cameras 10A to 10C. The cameras 10A to 10C obtain, respectively, captured images (split images) through split imaging. The captured images obtained by the cameras 10A to 10C are sent to the computer 60. Here, parts of the subject 11 are respectively pictured on the captured images obtained by the cameras 10A to 10C, and the captured images obtained by the cameras 10A to 10C are combined. Thus, a combination image on which the entire subject 11 is pictured can be obtained. The arrangement of the cameras 10A to 10C is not particularly limited. The cameras may be one-dimensionally arranged or two-dimensionally arranged. As for a combination direction of the combination image, a combination in a one-dimensional direction or a combination in a two-dimensional combination direction (matrix) may be performed. In a case where the subject 11 is a three-dimensional object, the cameras 10A to 10C may be three-dimensionally arranged. For example, in a case where the subject 11 is a vehicle, the cameras 10A to 10C may be arranged so as to surround the vehicle. The cameras 10A to 10C may be cameras of which angles of view (focal lengths) or the numbers of pixels are identical to each other, or cameras of which angles of view (focal length) or the numbers of pixels are different from each other.

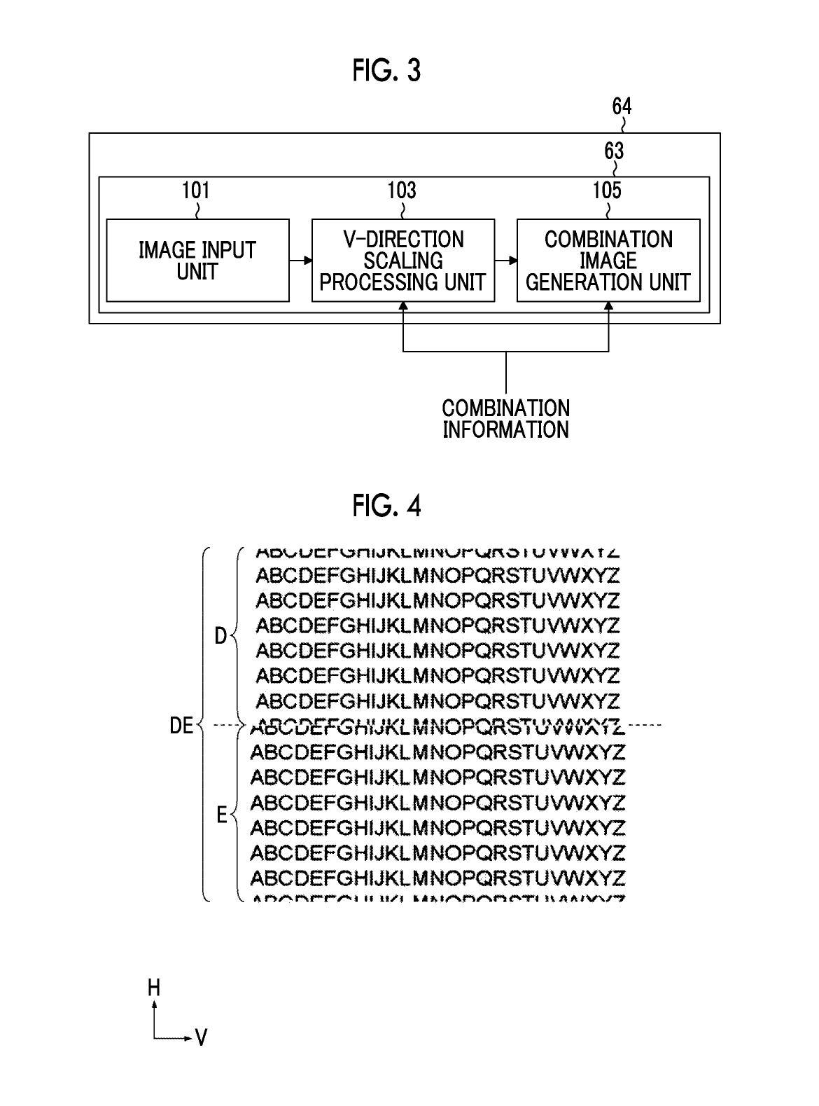

A computer-side image processing device (image processing unit) 63 (see FIG. 3) is provided in the computer 60. The plurality of captured images is combined by the computer-side image processing unit 63, and thus, the combination image is generated.

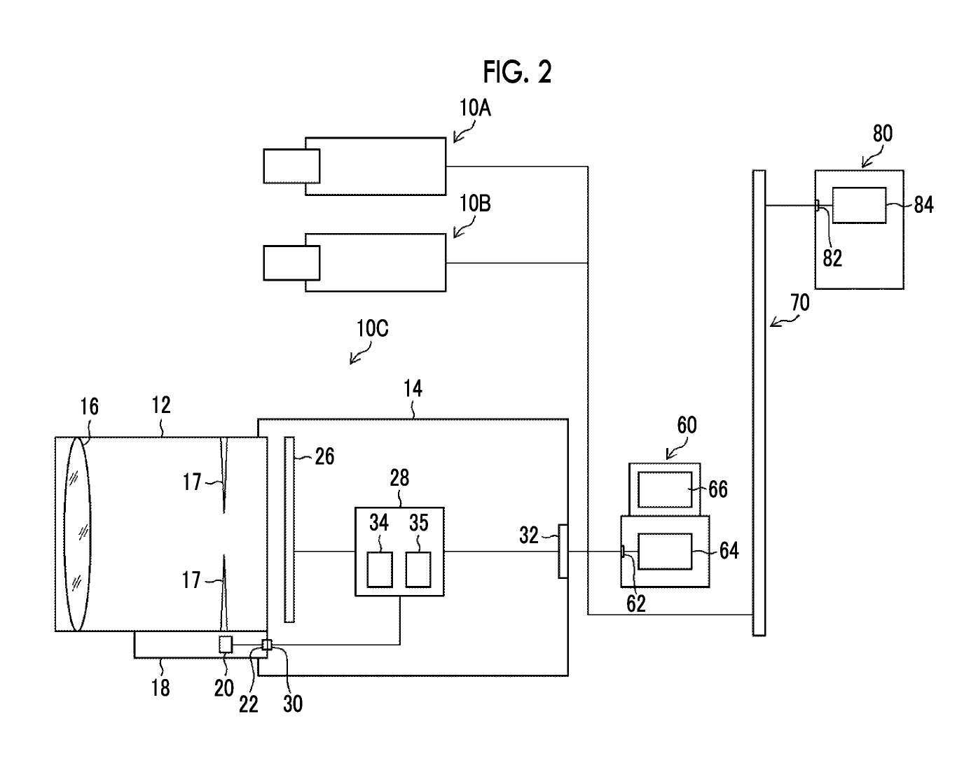

An angle of view of the subject 11 needs to be larger than an angle of view of an imaging lens provided in a lens unit 12 (see FIG. 2) of each of the cameras 10A to 10C, and the subject needs to be captured in the split manner by the cameras 10A to 10C. A specific example of the subject 11 includes a sheet produced at a factory, and specific examples of the cameras 10A to 10C include cameras for machine vision. For example, image recognition processing is performed on the combination image generated by the computer 60, and the combination image is used for inspection of the subject 11 (sheet) (surface inspection of the sheet). Another example of the camera includes a in-vehicle camera, a smartphone camera, or a surveillance camera.

FIG. 2 is a block diagram showing a function of each of the cameras 10A to 10C connected to the computer 60. Since the cameras 10A to 10C have the same configuration, only the configuration of the camera 10C is described, and the configurations of the cameras 10A to 10B are omitted.

The camera 10C comprises the lens unit 12, and a camera main body 14 including an imaging element 26. The lens unit 12 and the camera main body 14 are electrically connected through a lens-unit input and output unit 22 of the lens unit 12 and a camera-main-body input and output unit 30 of the camera main body 14.

The lens unit 12 includes an optical system such as a lens 16 and a stop 17 and an optical system operation unit 18 which controls the optical system. The optical system operation unit 18 includes a lens unit controller 20 connected to the lens-unit input and output unit 22, and an actuator (not shown) which operates the optical system. The lens unit controller 20 controls the optical system through the actuator based on a control signal sent from the camera main body 14 through the lens-unit input and output unit 22. For example, the lens-unit input and output unit performs focus control or zoom control based on lens movement or stop amount control of the stop 17.

The imaging element 26 of the camera main body 14 includes a concentration microlens, red (R), green (G), and blue (B) color filters, and an image sensor (photodiode; complementary metal oxide semiconductor (CMOS) or a charge-coupled device (CCD)). The imaging element 26 converts light of a subject image applied through the optical system (the lens 16 and the stop 17) of the lens unit 12 into electrical signals, and sends image signals to a camera main body controller 28. The cameras 10A to 10C can obtain a color image, a black and white image, or a monochromic image.

The camera main body controller 28 includes a device controller 34 and an image processing unit 35, and generally controls the camera main body 14. For example, the device controller 34 controls the output of the image signals (image data) from the imaging element 26, generates a control signal for controlling the lens unit 12, transmits the control signal to the lens unit 12 (lens unit controller 20) through the camera-main-body input and output unit 30, and transmits the image data (JPEG data) to an external device (computer 60) connected through an input and output interface 32. The device controller 34 appropriately controls various devices included in the camera 10C.

Meanwhile, the image processing unit 35 can perform any image processing as needed on the image signals from the imaging element 26. For example, various image processing such as sensor correction processing, demosaicing (synchronization) processing, pixel interpolation processing, color correction processing (offset correction processing, white balance processing, color matrix processing, or gradation correction processing), RGB image processing (sharpness processing, tone correction processing, exposure correction processing, or contour correction processing), RGB and/or YCrCb conversion processing, and image compression processing are appropriately performed by the image processing unit 35.

Image data on which the image processing is performed by the camera main body controller 28 is sent to the computer 60 through the input and output interface 32. A format of the image data sent to the computer 60 from the camera 10C (camera main body controller 28) is not particularly limited, and may be any format such as RAW, JPEQ or TIFF. Accordingly, the camera main body controller 28 generates one image file by associating a plurality of relevant data items such as header information (imaging information (an imaging date and time, a model, the number of pixels, and an F number)), main image data, and thumbnail image data with each other like an exchangeable image file format (Exif), and may transmit the image filer to the computer 60.

The computer 60 is connected to each of the cameras 10A to 10C through the input and output interface 32 of the camera main body 14 and a computer input and output unit 62, and receives data items such as the image data items sent from the camera main body 14. A computer controller 64 generally controls the computer 60, performs imaging processing on the image data items from the cameras 10A to 10C, and controls communication with a server 80 connected to the computer input and output unit 62 via a network such as the Internet 70. The computer 60 includes a display 66, and displays contents processed by the computer controller 64 on the display 66 as needed. A user operates input means (not shown) such as a keyboard while checking the display on the display 66, and thus, the user can input data or a command for the computer controller 64. Accordingly, the user can control the computer 60 or the devices (the cameras 10A to 10C and the server 80) connected to the computer 60. The computer-side image processing unit 63 (image processing device) included in the computer controller 64 of the computer 60 will be described below.

The server 80 includes a server input and output unit 82 and a server controller 84. The server input and output unit 82 constitutes a transmission and reception connection unit with an external device such as the computer 60, and is connected to the computer input and output unit 62 of the computer 60 through a network line such as the Internet 70. The server controller 84 transmits and receives data items to and from the computer controller 64 in cooperation with the computer controller 64 in response to a control command signal from the computer 60 as needed, downloads the data items to the computer 60, performs arithmetic processing, and transmits an arithmetic processing result to the computer 60.

The controllers (the lens unit controller 20, the camera main body controller 28, the computer controller 64, and the server controller 84) have circuits required in control processing, and each include, for example, an arithmetic processing circuit (central processing unit (CPU)) and a memory. Communication between the cameras 10A to 10C, the computer 60, and the server 80 may be wired communication or wireless communication.

### First Embodiment

FIG. 3 is a block diagram showing functions of the computer-side image processing unit (image processing device) 63 of the present embodiment. The computer-side image processing unit 63 is included in the computer controller 64 of the computer 60, and comprises an image input unit 101, a V-direction scaling processing unit 103, and a combination image generation unit 105.

The images captured by the plurality of cameras 10A to 10C are input to the image input unit 101. That is, the captured images captured by the cameras 10A to 10C are output from the input and output interface 32, and are input to the image input unit 101 through the computer input and output unit 62. The captured images input to the image input unit 101 are sent to the V-direction scaling processing unit 103.

The V-direction scaling processing unit 103 performs scaling processing on at least one image of two images to be combined with each other among the plurality of captured images in only a direction perpendicular to a direction in which the two images are combined. That is, the V-direction scaling processing unit 103 performs the scaling processing on the image in only a V direction, and does not perform the scaling processing on the image in the direction in which the images are combined. The direction perpendicular to the direction in which the two images are combined is also referred to as the V direction. The direction in which the images are combined is also referred to as an H direction.

The V-direction scaling processing unit 103 performs the scaling processing on at least one image of two images in the V direction according to a predetermined scaling ratio, and suppresses a misalignment on an image of a combined portion in a perpendicular direction. Accordingly, distortion of the combination image is partially corrected, and the combination image having favorable quality is obtained while suppressing calculation cost required in the scaling processing. The combined portion mentioned herein is a portion at which two adjacent captured images constituting the combination image are combined. A portion of one image of the captured images which has a width of 1% or more and 10% or less of a length of one side in the direction in which the one image is combined with the other image to be combined from a side at which the images are combined is referred to as the combination portion. The calculation cost mentioned in the present application is a load for the arithmetic processing circuit (CPU) of the computer 60.

Combination information is input to the V-direction scaling processing unit 103 and the combination image generation unit 105. The combination information mentioned herein is information for obtaining the combination image, and is, for example, a combination direction, a combination order, and a combination margin range. The combination information may be set in advance by the user, or may be input by the user by using the keyboard of the computer 60.

Hereinafter, a relationship between the direction in which the images are combined and a direction in which scaling correction is performed will be described. In the present disclosure, in particular, the scaling correction is performed in the V direction, and thus, effective distortion correction is realized. The distortion means that sizes of the two captured images to be combined are different or positions thereof are misaligned or that a shape of one captured image is changed due to an aberration of an imaging camera.

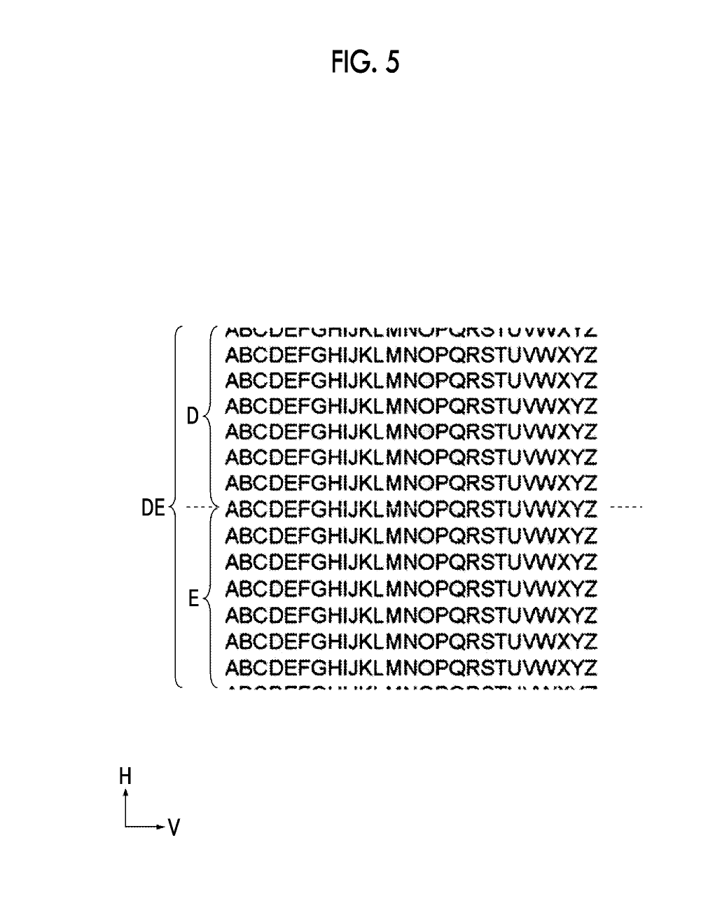

FIGS. 4 and 5 are diagrams for describing an apparent misalignment in a case where images having different sizes are combined. FIG. 4 shows a case where two images having sizes different from each other in the direction (H direction) in which the images are combined are combined, and FIG. 5 shows a case where two images having different from each other in the direction (V direction) perpendicular to the direction in which the images are combined are combined. FIG. 4 shows a case where a size of an image D in the V direction is 3% smaller than a size of an image E, and FIG. 5 shows a case where a size of the image D in the H direction is 3% smaller than a size of the image E.

Here, in a case where a combination image DE of FIG. 4 and a combination image DE of FIG. 5 are compared, the quality of the combination image DE (FIG. 4) in which the images having different sizes in the V direction are combined is further deteriorated than the quality of the combination image DE (FIG. 5) in which the images having different sizes in the H direction are combined. This shows that the influence of scaling in the direction (V direction) perpendicular to the combination direction (H direction) at the combined portion is larger than the influence of scaling in the combination direction. It can be seen that the scaling in the H direction at the combined portion rarely influence the impression of the quality given by the combination image.

In the present disclosure, the effective distortion correction of the combination image is performed while suppressing the calculation cost by using the fact well. Specifically, the V-direction scaling processing unit 103 effectively generates a combination image having favorable quality by performing only the scaling correction in the V direction.

The V-direction scaling processing unit 103 may perform the scaling processing on all the captured images in the V direction according to the same scaling ratio, may perform the scaling processing according to a scaling ratio corresponding to the position of the image in the V direction, or may perform the scaling processing according to a scaling ratio corresponding to pixels of the image arranged in the V direction.

The scaling ratio of the scaling processing performed by the V-direction scaling processing unit 103 is changed depending on the captured image, the combination image, the quality of the combination image desired by the user, and the purpose of use of the combination image, and various scaling ratios are applied.

Referring back to FIG. 3, the combination image generation unit 105 combines the plurality of captured images after the scaling processing using the V-direction scaling processing unit 103, and generates a continuous combination image. As the generation of the combination image performed by the combination image generation unit 105, the generation of the combination image in which the images after the scaling processing are combined is performed by using the known technology.

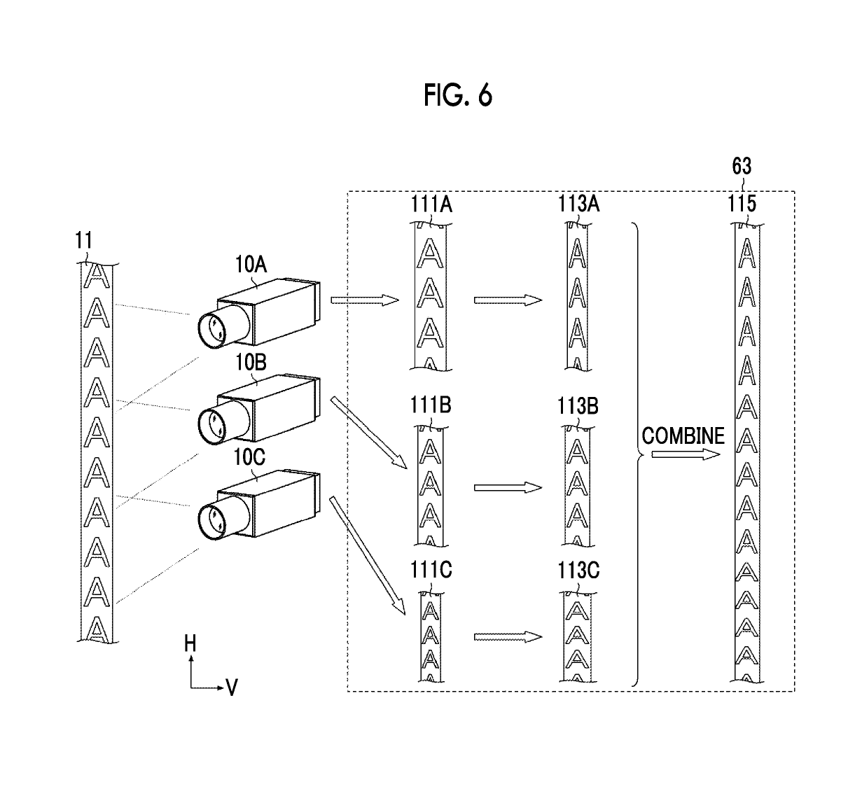

FIG. 6 is a diagram showing an outline until the combination image is generated.

The components already described in FIGS. 1 and 2 will be assigned the same references, and the description thereof will be omitted. A portion depicted by a dotted line conceptually represents processing performed by the computer 60. Here, a case where a combination image 115 is generated by combining captured images 111A to 111C along an H direction in the diagram is considered as illustrated in the diagram, and the direction perpendicular to the combination direction of the captured images is the V direction in the diagram.

The subject 11 is captured in the split manner by the cameras 10A to 10C. The cameras 10A to 10C obtain the captured images 111A to 111C, respectively, and send the captured images 111A to 111C to the computer-side image processing unit 63 of the computer 60. The captured images 111A to 111C are input to the image input unit 101. Here, the captured images 111A to 111C are captured with different focal lengths. That is, the captured image 111A is obtained with a focal length a, the captured image 111B is obtained with a focal length b, and the captured image 111C is obtained with a focal length c. The condition of a>b>c is satisfied.

As stated above, in a case where there is an attempt to generate the combination image by simply combining the captured images 111A to 111C having different focal lengths, since the sizes of the captured images 111A to 111C are different, the combination image is greatly distorted, and favorable quality is not obtained.

Thus, the scaling is performed on the captured images 111A to 111C by the V-direction scaling processing unit 103. Specifically, since the captured image 111A is the image captured with a long focal length, an intermediate image 113A is generated by performing the scaling processing for reducing the image in the V direction according to a predetermined scaling ratio. Since the captured image 111C is the image captured with a short focal length, an intermediate image 113C is generated by performing the scaling processing for enlarging the image in the V direction according to a predetermined scaling ratio. An intermediate image 113B is generated without performing the scaling processing with consideration for a balance between the captured image 111B and the captured images 111A and 111C. Thereafter, the combination image generation unit 105 generates a combination image 115 by combining the intermediate images 113A to 113C along the H direction.

The combination image 115 generated in this manner is not the combination image in which distortion is corrected for all the images, but the distortion thereof is effectively corrected. The combination image 115 is the image in which the distortion is sufficiently corrected for a specific purpose of use.

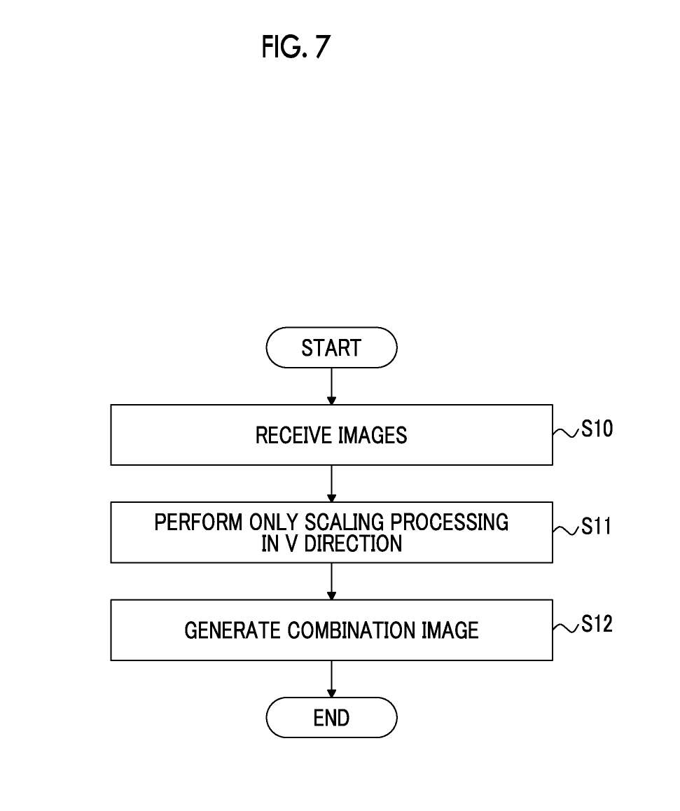

FIG. 7 is a flowchart showing an image processing method according to the embodiment of the present disclosure.

The plurality of captured images obtained by imaging one subject 11 in the split manner by the plurality of cameras 10A to 10C is initially input to the image input unit 101 (step S10: image input step). Thereafter, only the scaling processing in the V direction is performed on at least one image of two images to be combined with each other among the plurality of obtained images by the V-direction scaling processing unit 103 (step S11: scaling processing step). The two images including at least the one image on which the scaling processing is performed by the V-direction scaling processing unit 103 are combined by the combination image generation unit 105, and the combination image is generated (step S12: combination image generation step).

The aforementioned components and functions can be appropriately realized by any hardware or software, or a combination thereof. For example, the present disclosure can be applied to a program causing a computer to perform the aforementioned processing steps (processing procedure), a computer-readable recording medium (non-transitory recording medium) that records the program, or a computer on which the program can be installed.

In the present embodiment, a hardware structure of a processing unit that performs various processing includes various processors to be described below. As the various processors, there are a CPU which is a general-purpose processor functioning as various processing units by executing software (program), a programmable logic device (PLD) which is a processor capable of changing a circuit configuration after Field Programmable Gate Array (FPGA) is manufactured, and a dedicated electric circuit which is a processor having a circuit configuration designed as a dedicated circuit in order to perform specific processing such as an Application Specific Integrated Circuit (ASIC).

One processing unit may be constituted by one of the various processors, or may be constituted by the same kind or different kinds of two or more processors (for example, a plurality of FPGAs, or a combination of the CPU and the FPGA). A plurality of processing units may be constituted by one processor. As the example in which the plurality of processing units is constituted by one processor, there is a first aspect in which one processor is constituted by a combination of one or more CPUs and software as represented by a computer such as a client or a server, and the processor functions as the plurality of processing units. There is a second aspect in which a processor that realizes the functions of the entire system including the plurality of processing units by one integrated circuit (IC) chip as represented by a system on chip (SoC) is used. As stated above, the various processing units are constituted by using one or more of the various processors as the hardware structure.

More specifically, the hardware configuration of the various processors is an electric circuitry in which circuit elements such as semiconductor elements are combined.

### Second Embodiment

Hereinafter, a second embodiment will be described. The present embodiment is different from the first embodiment, and scaling in the direction (H direction) in which the images are combined is also performed.

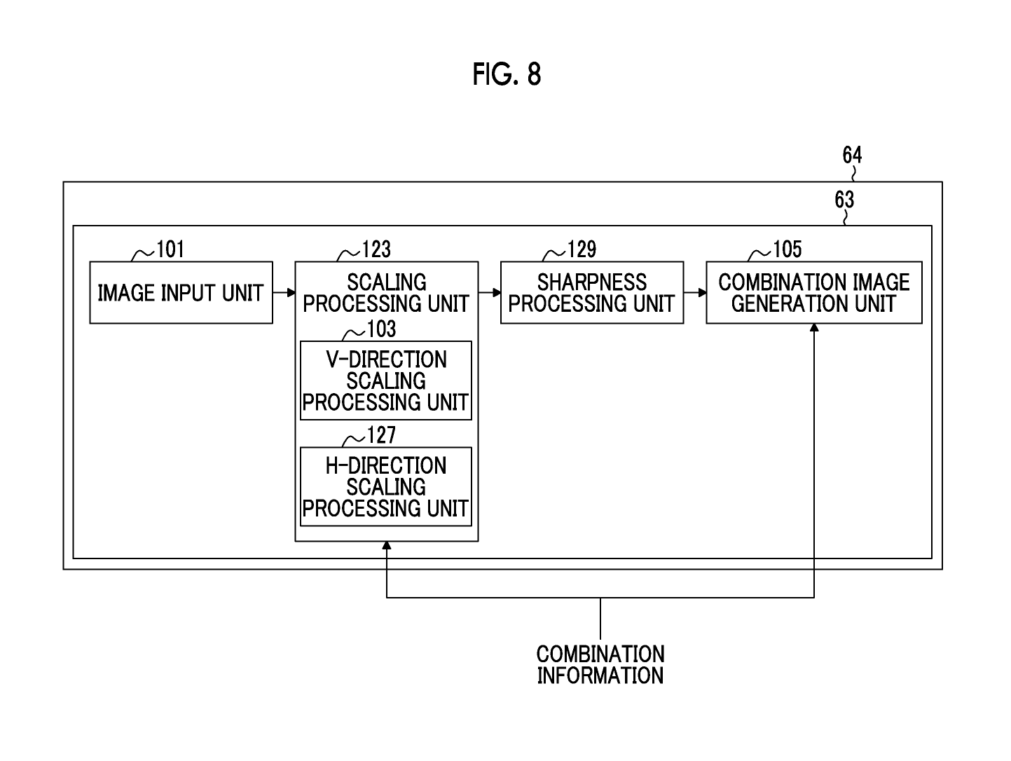

FIG. 8 is a block diagram showing functions of the computer-side image processing unit (image processing device) 63 of the present embodiment. The computer-side image processing unit 63 is provided in the computer controller 64 of the computer 60, and comprises the image input unit 101, the scaling processing unit 123, and the combination image generation unit 105. The portions described in FIG. 3 will be assigned the same references, and the description thereof will be omitted.

The scaling processing unit 123 of the present embodiment comprises the V-direction scaling processing unit (first scaling processing unit) 103, and an H-direction scaling processing unit (second scaling processing unit) 127.

The H-direction scaling processing unit 127 performs scaling processing on a partial image including an image of a combined portion of at least one image of two images in the direction (H direction) in which the two images are combined. That is, the H-direction scaling processing unit 127 performs the scaling processing on not the entire captured image but the partial image including the image of the combined portion in the H direction.

The H-direction scaling processing unit 127 performs the scaling processing on a partial image of at least one image of two images according to a predetermined scaling ratio, suppresses a misalignment or distortion on an image of a combined portion of the two images to be combined with each other in the H direction, and causes the image to be continuous. That is, the H-direction scaling processing unit 127 corrects the misalignment or distortion of the image of the combined portion of the two images and causes the image to be continuous by performing the scaling processing on the partial image including the combined portion of the captured images in the H direction.

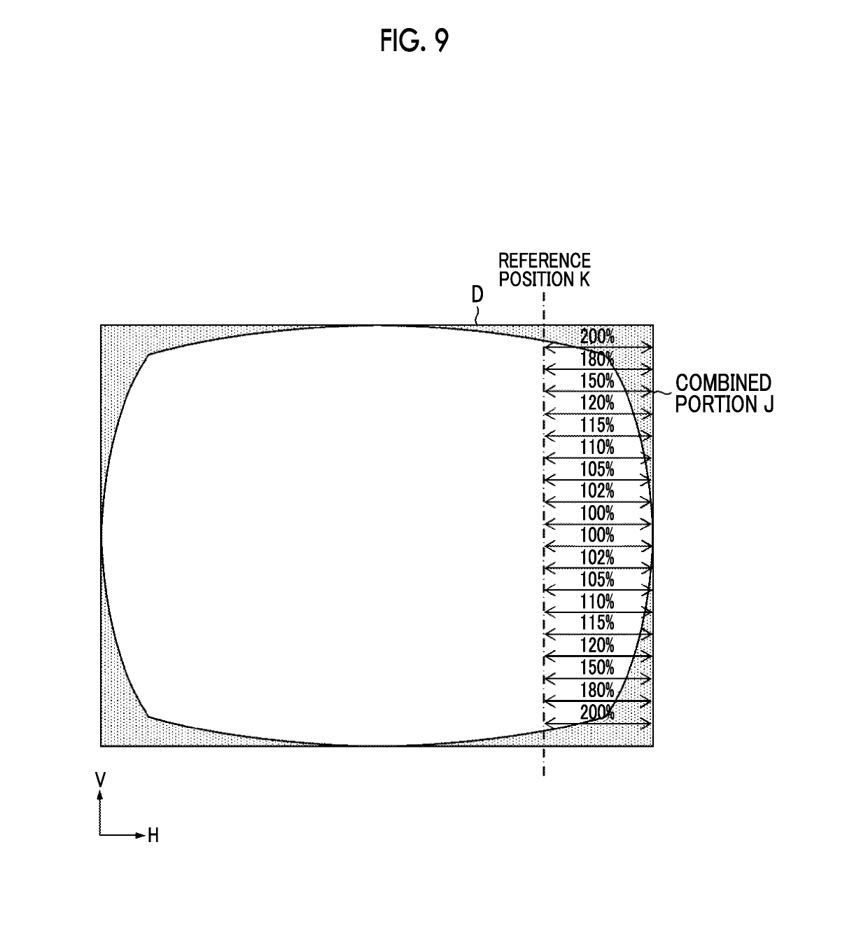

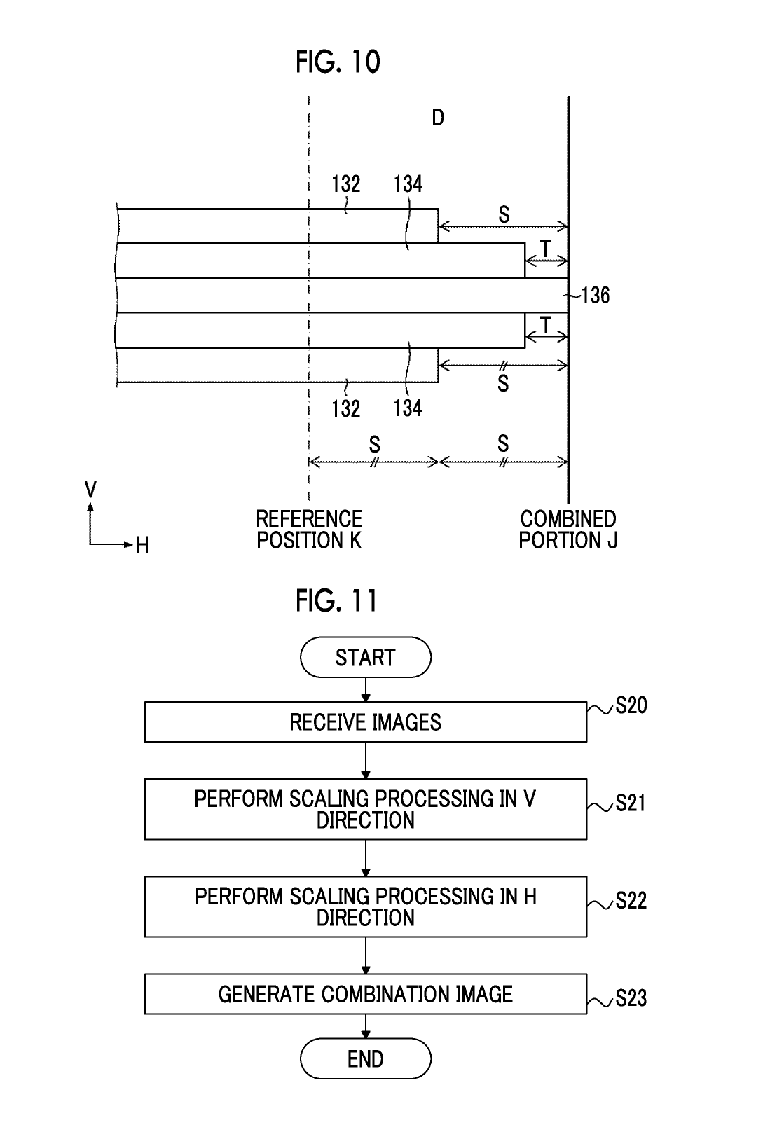

FIGS. 9 and 10 are diagrams for describing the scaling processing in the H direction performed by the H-direction scaling processing unit 127.

The scaling processing on a captured image D in the H direction is conceptually shown in FIG. 9. The captured image D has a barrel distortion with respect to an image to be in a square shape. The H-direction scaling processing unit 127 performs the scaling processing on a partial image including a combined portion J having a side (combination side) at which the captured image D is combined with the other image in the H direction. Specifically, an area surrounded by a reference position K and the combination side of the combined portion J, that is, the partial image including the combined portion is enlarged in the respective positions according to scaling ratios of 100%, 102%, 105%, 110%, 115%, 120%, 150%, and 200%, as shown in the diagram. In this scaling processing, the image is enlarged in the H direction from the reference position. Here, the partial image including the combined portion J of the captured image D is the area surrounded by the reference position K and the combination side of the combined portion J, and has a width of 1% or more and 10% or less of a length of one side of the captured image D in the H direction.

The H-direction scaling processing unit 127 may perform the scaling in the H direction until the combination side of the combined portion J but may perform the scaling so as to extend beyond the combination side of the combined portion J.

FIG. 10 is a diagram for describing the reference position K. As stated above, the reference position K is a position at which an area where the scaling processing in the H direction is performed is determined.

In the case shown in FIG. 10, the scaling processing in the H direction is performed on a portion of a reference 132, a portion of a reference 134, and a portion of a reference 136 according to different scaling ratios. Specifically, the portion of the reference 132 is enlarged in the H direction by S, and the portion of the reference 134 is enlarged in the H direction by T. In the case shown in FIG. 10, the portion of the reference 132 is enlarged the most. In this case, for example, the reference position K can be formed in a position separated from an end portion to be combined by 2S. That is, the reference position K is formed in a position which is separated by twice a distance to be enlarged at the portion enlarged the most. As stated above, the reference position K is not formed at the center of a screen, and thus, the number of times of correction is reduced. Accordingly, the calculation cost is suppressed.

Referring back to FIG. 8, a sharpness processing unit 129 performs sharpness processing on the captured image after the scaling processing is performed. The sharpness processing unit 129 performs the sharpness processing on the captured image constituting the combination image, and performs the sharpness processing on the image on which the scaling processing is performed and the image on which the scaling processing is not performed. Here, the known technology is used as the sharpness processing performed by the sharpness processing unit 129.

FIG. 11 is a flowchart showing the image processing method according to the embodiment of the present disclosure.

The plurality of captured images obtained by imaging one subject 11 in the split manner by using the plurality of cameras 10A to 10C is initially input to the image input unit 101 (step S20: image input step). Thereafter, the scaling processing in the V direction is performed on at least one image of two images to be combined with each other among the plurality of images obtained by the V-direction scaling processing unit 103 (step S21: first scaling processing step). Subsequently, the H-direction scaling processing unit 127 performs the scaling processing on the partial image including the image of the combined portion of at least the one image of the two images to be combined with each other in the direction in which the two images are combined (step S22: second scaling processing step). Thereafter, the combination image generation unit 105 combines the two images including at least the one image on which the scaling processing is performed by the V-direction scaling processing unit 103 and the H-direction scaling processing unit 127 and generates the combination image (step S23: combination image generation step).

<Examples of Combination Image>

Hereinafter, examples of the combination image combined in the present disclosure will be described. Although one combination image is generated by using two captured images as the examples of the combination image to be described below, the application range of the present disclosure is not limited thereto. The present disclosure is applied to a case where one combination image is naturally generated by using three or more captured images.

### Example 1 of Combination Image

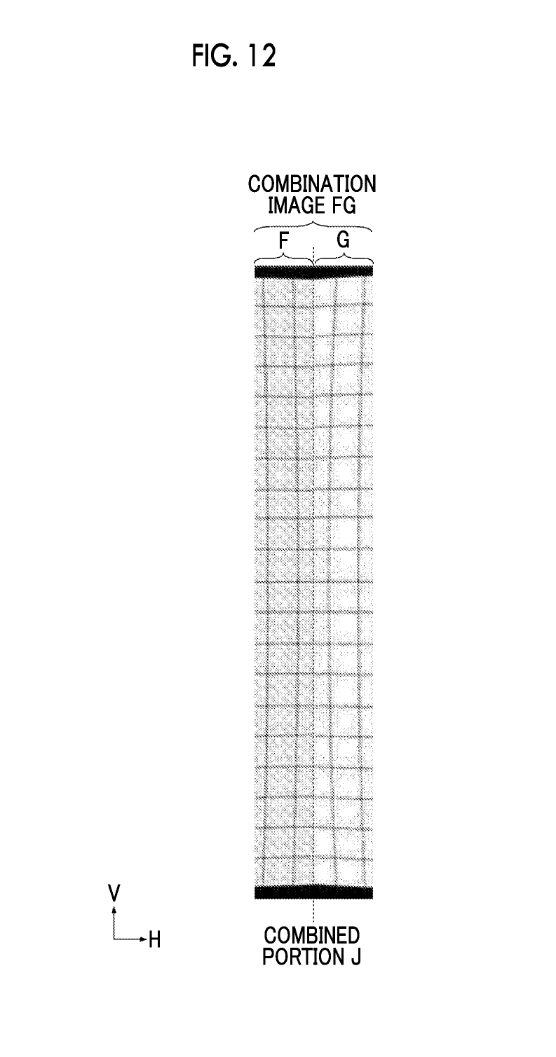

FIG. 12 is a diagram showing a combination image of the present example. A combination image FG of a captured image F and a captured image G is shown in FIG. 12. The sizes of the captured image F and the captured image G are aligned at the combined portion J of the captured image. Specifically, the V-direction scaling processing unit 103 aligns the sizes of the images at the combined portion J by performing the scaling processing on the captured images F and/or G.

Here, even though distortion is caused over five pixels or more on the captured image input to the image input unit 101 in the V direction, it is possible to generate a combination image on which an object can be recognized by performing the scaling processing by the V-direction scaling processing unit 103. That is, in a case where the combination image is used for recognizing the object on the image, the misalignment of the image is corrected over preferably four pixels or less, and more preferably 2 pixels or less. However, the distortion can be corrected over preferably four pixels or less, and more preferably two pixels or less on the combination image through the scaling processing according to the present disclosure.

### Example 2 of Combination Image

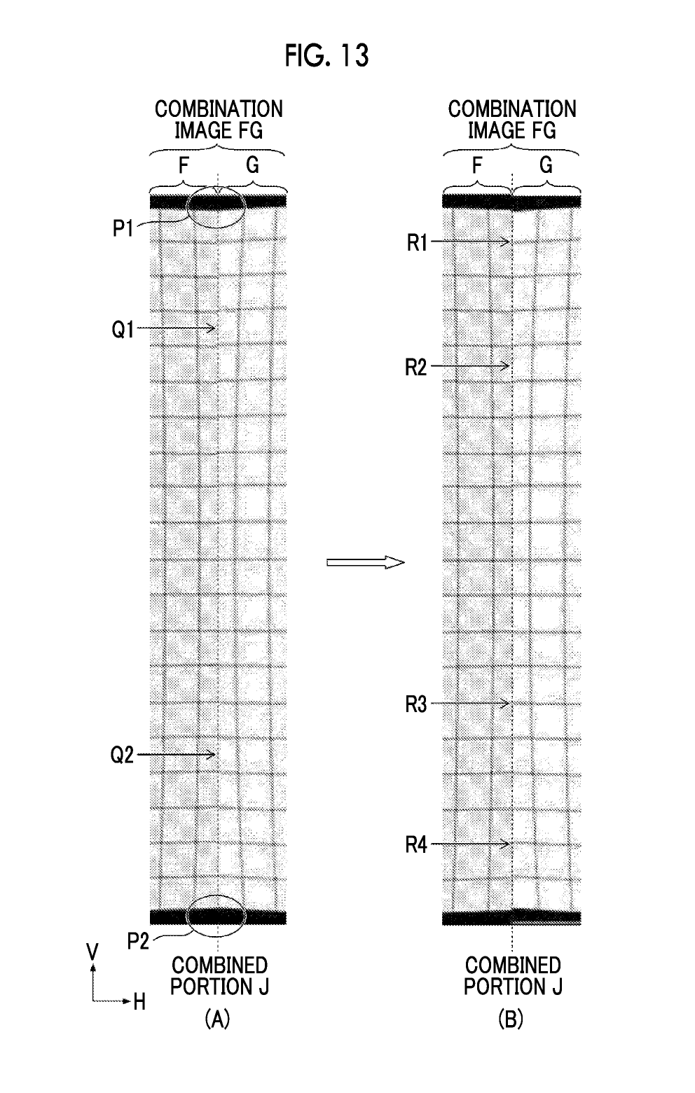

FIG. 13 is a diagram showing a combination image of the present example. The combination image FG shown in FIG. 12 is shown in (A) of FIG. 13 for comparison, and the combination image of the present example is shown in (B) of FIG. 13.

In a case where the scaling processing is performed such that ends of the captured image F and the captured image G are aligned as shown in FIG. 12, the ends of the captured images are aligned (there is no level difference at the combined portion J), but portions at which distortion greatly remains are formed at middle portions between the captured images in some cases.

For example, in the case shown in (A) of FIG. 13, there is no misalignment (level difference) between the captured image F and the captured image G at end portions P1 and P2, but distortion is greatly caused in a position Q1 and a position Q2.

Meanwhile, in (B) of FIG. 13, the scaling processing is performed according to a scaling ratio at which the images can be combined at a plurality of points of the combined portion J with a good balance. That is, in FIG. 13, the scaling processing is performed by setting not the scaling ratio at which the end portions of the combined portion J are aligned but the scaling ratio at which the images can be combined at the plurality of points of the combined portion J in the V direction with a good balance. Accordingly, for example, distortion is further suppressed in R1 to R4 of (B) of FIG. 13 than in the case (A) of FIG. 13.

(Example 3 of Combination Image)

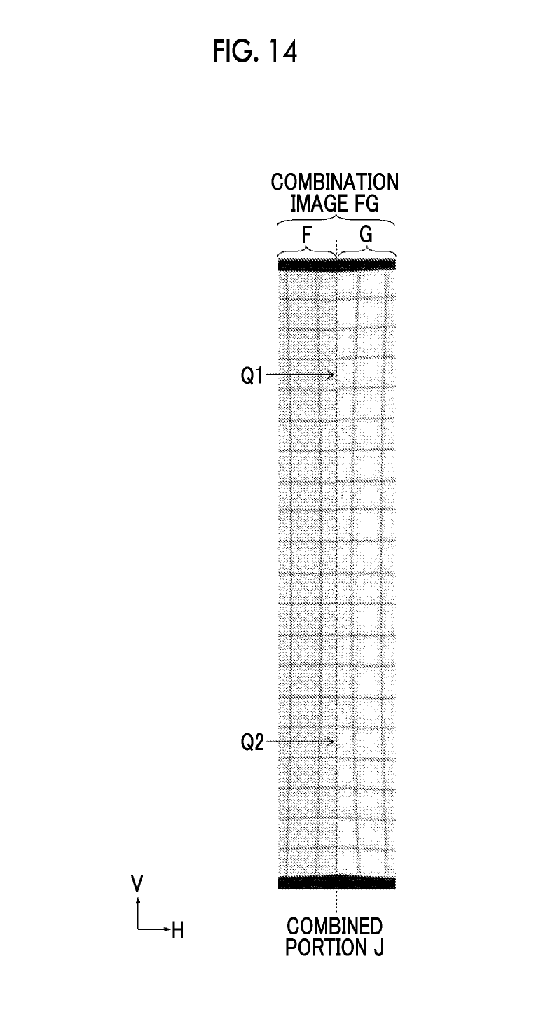

FIG. 14 is a diagram showing a combination image of the present example. The combination image FG shown in FIG. 14 is the combination image FG described in FIG. 12. That is, the combination image FG is obtained by performing the scaling processing according to the scaling ratio at which the sizes of the images at the end portions of the combined portion J are aligned (there is no level difference). In this case, for example, distortion is greatly caused at middle portions of the image such as Q1 or Q2. Thus, in the present example, the scaling processing is performed at the portions where the distortion is greatly caused according to different scaling ratios as stated above. That is, in the present example, the scaling processing is performed according to different scaling ratios corresponding to the pixels or the positions in the V direction.

(Example 4 of Combination Image)

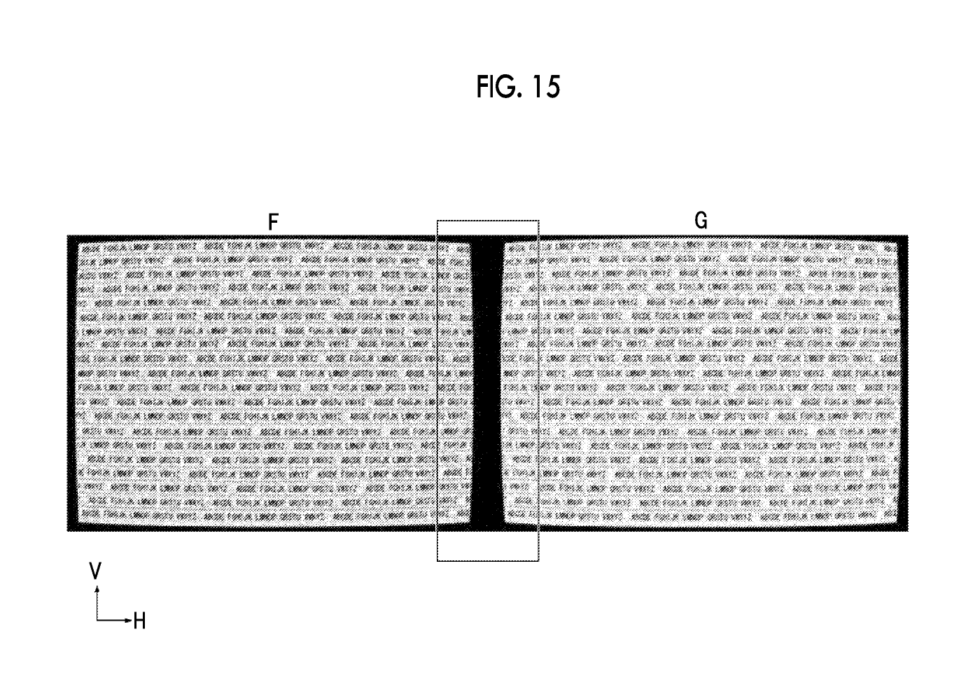

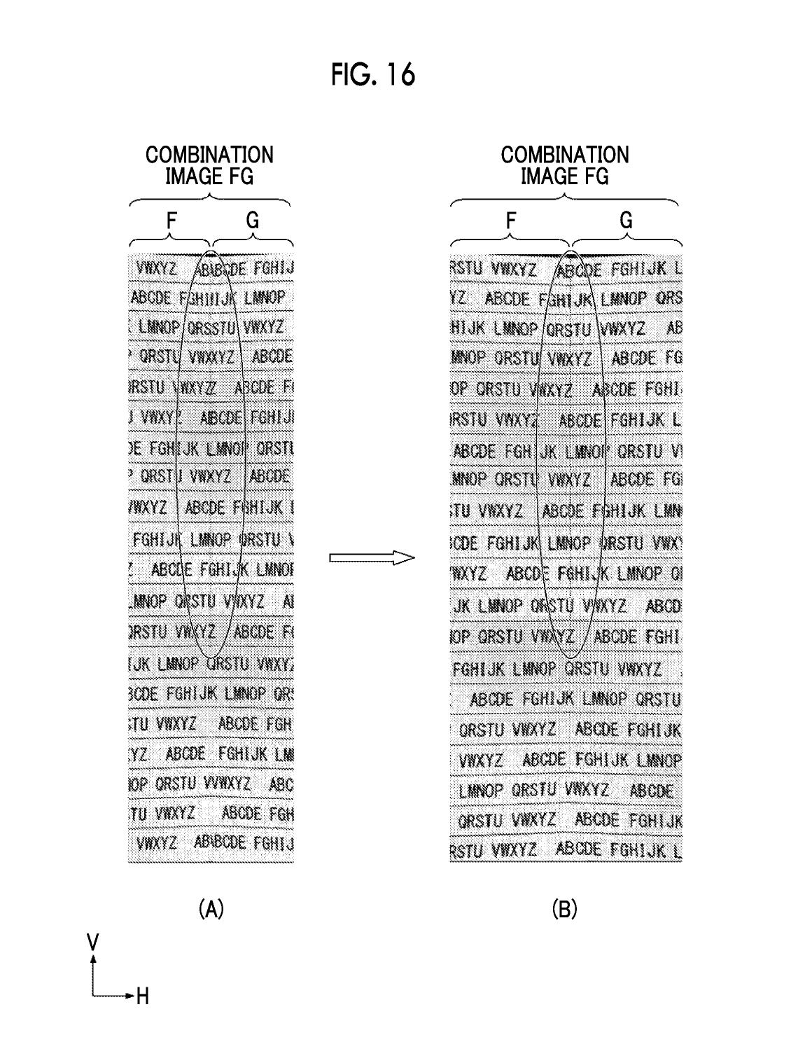

FIGS. 15 and 16 are diagrams showing combination images of the present example. The scaling processing in the H direction is also performed on the combination images of the present example.

FIG. 15 shows the captured image F and the captured image G constituting the combination image. The captured images F and G have barrel aberrations, respectively.

The captured images F and G have texts in the H direction. As stated above, in a case where a combination image is generated by combining captured images having sentences, characters, or fine structures, it is easy to perceive distortion in the H direction. Accordingly, the scaling processing is also performed in the H direction.

(A) of FIG. 16 shows a case where the captured image F and the captured image G are combined without performing the scaling processing in the H direction, and (B) of FIG. 16 shows a case where the captured image F and the captured image G are combined by performing the scaling processing in the H direction.

As shown in (A) of FIG. 16, in a case where the scaling processing in the H direction is not performed on the captured image F and the captured image the texts are not continuous well on the combination image FG in some cases. That is, the captured images are not continuous well in the H direction due to the aberrations of the individual captured images in some cases. In such a case, the scaling processing in the H direction is performed.

As shown in (B) of FIG. 16, in a case where the scaling processing in the H direction is performed on the captured image F and/or the captured image the texts are continuous well on the combination image FG That is, in a case where the scaling processing in the H direction is performed on the captured image F and/or the captured image the texts of the captured image F and the captured image G are continuous well.

While the examples of the present disclosure have been described, the present disclosure is not limited to the aforementioned embodiments, and can be variously modified without departing from the gist of the present disclosure.

### EXPLANATION OF REFERENCES

10A to 10C: camera
11: subject
12: lens unit
14: camera main body
16: lens
17: stop
18: optical system operation unit
20: lens unit controller
22: lens-unit input and output unit
26: imaging element
28: camera main body controller
30: camera-main-body input and output unit
32: input and output interface
34: device controller
35: image processing unit
60: computer
62: computer input and output unit
63: computer-side image processing unit
64: computer controller
66: display
70: Internet
80: server
82: server input and output unit
84: server controller
101: image input unit
103: V-direction scaling processing unit
105: combination image generation unit
111A to 111C: captured image
113A to 113C: intermediate image
115: combination image
123: scaling processing unit
127: H-direction scaling processing unit
129: sharpness processing unit

What is claimed is:

1. An image processing device comprising:
an image input unit that receives, as inputs, a plurality of images captured by a plurality of cameras;
a scaling processing unit that performs scaling processing on at least one image of two images to be combined with each other among the plurality of images in only a direction perpendicular to a direction in which the two images are combined; and
a combination image generation unit that combines the plurality of images after the scaling processing using the scaling processing unit, and generates a continuous combination image,
wherein the scaling processing unit performs the scaling processing on at least the one image of the two images according to a predetermined scaling ratio, and suppresses a misalignment on an image of a combined portion at which the two images are combined with each other in the perpendicular direction.

2. The image processing device according to claim 1,
wherein the scaling processing unit performs the scaling processing according to the predetermined scaling ratio, and aligns a size of the image of the combined portion.

3. The image processing device according to claim 1,
wherein the scaling processing unit performs the scaling processing according to the predetermined scaling ratio corresponding to a position of the one image in the perpendicular direction.

4. The image processing device according to claim 2,
wherein the scaling processing unit performs the scaling processing according to the predetermined scaling ratio corresponding to a position of the one image in the perpendicular direction.

5. The image processing device according to claim 1,
wherein the scaling processing unit performs the scaling processing according to the predetermined scaling ratio corresponding to pixels of the one image in the perpendicular direction.

6. The image processing device according to claim 1,
wherein the scaling processing unit performs the scaling processing on at least the one image of the two images as a whole according to the same predetermined scaling ratio.

7. An image processing device comprising:
an image input unit that receives, as inputs, a plurality of images captured by a plurality of cameras;
a first scaling processing unit that performs scaling processing on at least one image of two images to be combined with each other among the plurality of images in a direction perpendicular to a direction in which the two images are combined;
a second scaling processing unit that performs the scaling processing on a partial image including an image of a combined portion, at which the two images are combined with each other, of at least the one image of the two images in the direction in which the two images are combined; and
a combination image generation unit that combines the plurality of images after the scaling processing using the first scaling processing unit and the second scaling processing unit, and generates a continuous combination image,
wherein the first scaling processing unit performs the scaling processing on at least the one image of the two images according to a first predetermined scaling ratio, and suppresses a misalignment on the image of the combined portion of the two images to be combined with each other in the perpendicular direction, and
the second scaling processing unit performs the scaling processing on the partial image according to a second predetermined scaling ratio, suppresses a misalignment or distortion on the image of the combined portion of the two images to be combined with each other, and causes the image to be continuous in the combination direction.

8. The image processing device according to claim 7,
wherein the first scaling processing unit performs the scaling processing according to the first predetermined scaling ratio, and aligns a size of the image of the combined portion.

9. The image processing device according to claim 7,
wherein the first scaling processing unit performs the scaling processing according to the first predetermined scaling ratio corresponding to a position of the one image in the perpendicular direction.

10. The image processing device according to claim 7,
wherein the first scaling processing unit performs the scaling processing according to the first predetermined scaling ratio corresponding to pixels of the one image in the perpendicular direction.

11. The image processing device according to claim 7,
wherein the first scaling processing unit performs the scaling processing on at least the one image of the two images as a whole according to the same first predetermined scaling ratio.

12. The image processing device according to claim 7,
wherein the second scaling processing unit performs the scaling processing on the partial image depending on a position of the one image in the perpendicular direction.

13. The image processing device according to claim 7,
wherein the second scaling processing unit performs the scaling processing on the partial image depending on pixels of the one image in the perpendicular direction.

14. The image processing device according to claim 7,
wherein the partial image has a width of 1% or more and 10% or less of a length of one side of the image to be combined in the combination direction.

15. The image processing device according to claim 1, further comprising:
a sharpness processing unit that performs sharpness processing on the plurality of images on which the scaling processing is performed.

16. The image processing device according to claim 1,
wherein distortion is caused over five pixels or less on the combination image generated by the combination image generation unit.

17. An image processing method using the image processing device according to claim 1 comprising:
an image input step of receiving, as inputs, the plurality of images captured by a plurality of cameras;
a scaling processing step of performing scaling processing on at least one image of two images to be combined with each other among the plurality of images in only the direction perpendicular to the direction in which the two images are combined; and
a combination image generation step of combining the plurality of images after the scaling processing in the scaling processing step, and generating the continuous combination image,
wherein, in the scaling processing step, the scaling processing is performed on at least the one image of the two images according to the predetermined scaling ratio, and the misalignment on an image of a combined portion at which the two images are combined with each other in the perpendicular direction is suppressed.

18. An image processing method using the image processing device according to claim 7 comprising:
an image input step of receiving, as inputs, the plurality of images captured by the plurality of cameras;
a first scaling processing step of performing scaling processing on at least one image of two images to be combined with each other among the plurality of images in the direction perpendicular to the direction in which the two images are combined;
a second scaling processing step of performing the scaling processing on the partial image including the image of the combined portion, at which the two images are combined with each other, of at least the one image of the two images in the direction in which the two images are combined; and
a combination image generation step of combining the plurality of images after the scaling processing in the first scaling processing step and the second scaling processing step, and generating the continuous combination image,
wherein, in the first scaling processing step, the scaling processing is performed on at least the one image of the two images according to the first predetermined scaling ratio, and the misalignment on the image of the combined portion of the two images to be combined with each other in the perpendicular direction is suppressed, and
in the second scaling processing step, the scaling processing is performed on the partial image according to the second predetermined scaling ratio, the misalignment or distortion on the image of the combined portion of the two images to be combined with each other is suppressed, and the image is continuous in the combination direction.

19. A non-transitory computer readable recording medium storing a program causing a computer to perform:
an image processing method including an image input step of receiving, as inputs, a plurality of images captured by a plurality of cameras,
a scaling processing step of performing scaling processing at least one image of two images to be combined with each other among the plurality of images in only a direction perpendicular to a direction in which the two images are combined, and
a combination image generation step of combining the plurality of images after the scaling processing in the scaling processing step, and generating a continuous combination image,
wherein, in the scaling processing step, the scaling processing is performed on at least the one image of the two images according to a predetermined scaling ratio, and a misalignment on an image of a combined portion at which the two images are combined with each other in the perpendicular direction is suppressed.

20. A non-transitory computer readable recording medium storing a program causing a computer to perform:
an image processing method including an image input step of receiving, as inputs, a plurality of images captured by a plurality of cameras,
a first scaling processing step of performing scaling processing on at least one image of two images to be combined with each other among the plurality of images in a direction perpendicular to a direction in which the two images are combined,
a second scaling processing step of performing the scaling processing on a partial image including an image of a combined portion, at which the two images are combined with each other, of at least the one image of the two images in the direction in which the two images are combined, and
a combination image generation step of combining the plurality of images after the scaling processing in the first scaling processing step and the second scaling processing step, and generating a continuous combination image,
wherein, in the first scaling processing step, the scaling processing is performed on at least the one image of the two images according to a first predetermined scaling ratio, and a misalignment on the image of the combined portion of the two images to be combined with each other in the perpendicular direction is suppressed, and
in the second scaling processing step, the scaling processing is performed on the partial image according to a second predetermined scaling ratio, a misalignment or distortion on the image of the combined portion of the two images to be combined with each other is suppressed, and the image is continuous in the combination direction.
